(19) United States
(12) Patent Application Publication
(10) Pub. No.: US 2010/0006237 A1
(43) Pub. Date: Jan. 14, 2010

(54) Floor-Supported Partition System

(76) Inventor: Walter W. Claypool, Sandy Lake, PA (US)

Correspondence Address: JAMES R. WILLIAMS, 3103 WILMINGTON ROAD, NEW CASTLE, PA, 16105, US

(21) Appl. No.: 12/500,246

(22) Filed: Jul. 9, 2009

Related U.S. Application Data
(60) Provisional application No. 61/079,536, filed on Jul. 10, 2008.

(51) Int. Cl. E05D 15/08; E04B 1/343

(52) U.S. Cl. 160/201; 52/243.1

(57) ABSTRACT

A floor-supported partition system includes at least one support pole having an upper end mechanically connected to at least one trolley and a lower end attached to a weight bearing member. A partition is attached to the support pole so that the partition and support pole move in unison. The trolley travels along a channel fixed to the ceiling. The weight bearing member is capable of moving along the floor while transferring the weight of the partition system to the floor.

The present invention is being submitted as a provisional application under 37 CFR 1.53(c).

### FIELD OF THE INVENTION

The invention relates to partitions, in particular to partitions to be used as movable room dividers.

### BACKGROUND

Partitions are frequently used to divide large areas into smaller areas or rooms, and include movable partitions such as, for example, accordion partitions and movable wall panels. One type of partition includes a movable partition suspended from overhead supports. Supports can include a plurality of trolleys riding on a track. The track must support substantially the entire weight of the movable partition. The strength of the track and its anchoring system largely determines the type of movable partition that can be used. For example, suspended ceilings are capable of supporting only very light vertical loads and consequently can support only light-weight movable partitions, such as for example, the pull-curtains found in hospital rooms. Heavier movable partitions can be installed with suspended ceilings provided the support is fixed to a ceiling member that is capable of supporting the weight of the movable partition. Unfortunately, installation usually involves removing, reinforcing, or replacing at least a portion of the ceiling, and can also require installation of acoustical barriers and privacy panels. This type of installation can be quite expensive and may well interrupt normal activity for several days.

Floor-supported movable partitions can transfer much of the load-bearing duty from the overhead supports and can be used without significantly altering the ceilings. Unfortunately, such partitions require an in-floor track as well as some overhead support at least for lateral stability. Prior art includes a partition comprising a plurality of movable wall elements hanging from an overhead fixture but riding on a floor support. The floor support includes a plurality of bearings riding in a floor track. The in-floor track presents both practical and aesthetic problems because the track can be both a trip hazard and a catch-all for debris. Installation can significantly disrupt normal activity as the track is placed in the floor and the ceiling may have to be altered.

Alternative partition systems include office-type partitions and portable screens. Office-type partitions include floor and ceiling channels for fixing the partition in place and for providing lateral stability. These partitions are not easily moved or removed, and require significant labor to effect any change. Portable screens and partitions typically are carried or wheeled into place. They can be placed quickly with little or no alteration of the room. Unfortunately, their weight and bulk increases with the area to be partitioned and limits the use of portable screens and partitions to smaller areas. Furthermore, portable screens and partitions generally do not extend completely to the ceiling and so do not provide complete acoustical and sight privacy. They also do not provide ample lateral stability or security for many applications.

Prior art does not include a partition that is easily-movable, stable, fast and inexpensive to install, without alteration of the existing floor or ceiling and with effective sight and sound barriers for occupants in adjoining interior spaces.

### SUMMARY

A floor supported partition system includes a support pole having an upper end mechanically connected to at least one trolley and a lower end contacting the floor. A partition is attached to the support pole so that the partition and support pole move in unison. The partition is commonly attached between two adjacent support poles. Optionally, the partition includes a partition frame and the support pole is fixed to the partition frame. The trolley travels along a channel fixed to the ceiling. The lower end is attached to a weight bearing member capable of moving along the floor while transferring the weight of the partition system to the floor. The partition system can include a plurality of support poles and trolleys.

In embodiments, the channel can comprise a track along which the trolley can travel. The channel can transfer non-vertical loads from the track to the ceiling, thus providing lateral stability for the partition. Preferably, the channel permits at least some vertical motion of the support pole, and must have sufficient strength to resist sagging, bending, bowing, and lateral forces.

In other embodiments, the track includes an upper raceway and a lower raceway. A truck can include an upper trolley that moves along the upper raceway and a lower trolley that rides along the lower raceway. The truck can improve stability over a single trolley, particularly in the aft and lateral planes.

In aspects, the weight bearing member can include at least one wheel or slide that can be moved across the floor when desired but will otherwise remain in place. Fixing the weight bearing member in place can include, for example, the use of a brake. A plurality of support poles can share one or more weight bearing members. The weight bearing member preferably includes a castor. The castor offsets the weight bearing member from a vertical axis of the support pole so that, when the support pole moves, the castor directs the weight bearing member toward the vertical axis. The castor preferably rotates in a horizontal plane so that the weight bearing member moves the support pole toward the vertical axis.

In another aspect, the support pole includes a tensioner that permits variations in the height of the support pole. The tensioner can include a compressible element. The tensioner is particularly useful when the floor is not level and can also provide an upward force that resists movement of the trolley from the channel.

### BRIEF DESCRIPTION OF THE DRAWINGS

FIG. 1 is a cross-section of the invention along a lateral plane.

FIG. 2 is a cross-section of the invention along a direction of motion.

FIG. 3 shows a support pole, weight bearing member, and trolley.

FIG. 4 shows a weight bearing member.

FIG. 5 shows the planes of motion.

FIG. 6 shows a top of the support pole.

FIG. 7 shows one embodiment of the weight bearing member.

### DETAILED DESCRIPTION

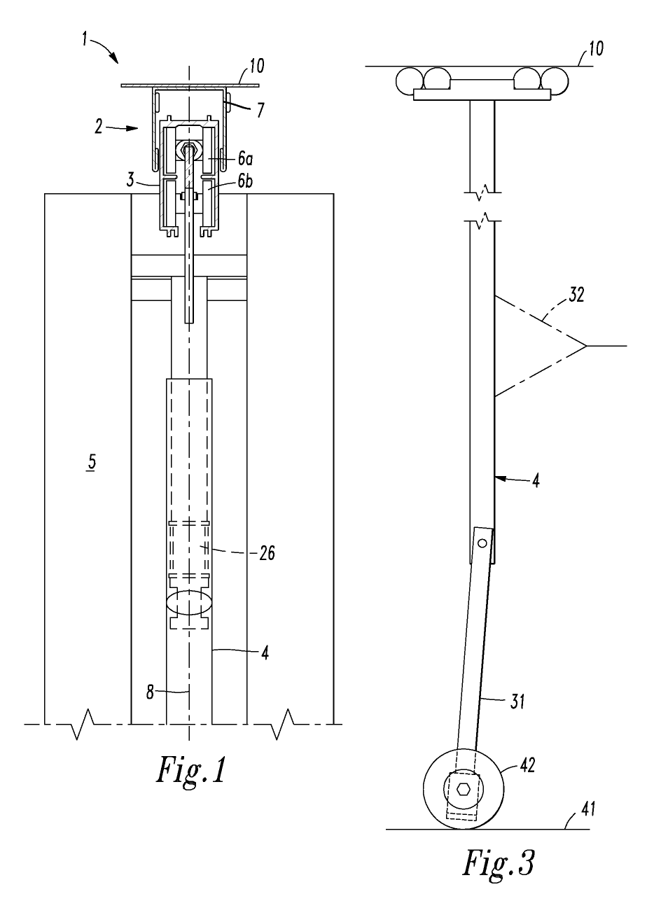

As shown in FIGS. 1-3, the partition system 1 comprises a channel 2, at least one trolley 6, a support pole 4, a partition 5, and a weight bearing member 42. The partition system 1 can be extended along a direction of motion 50 in order to at least partially isolate one room area from another, thereby creating a plurality of spaces. Alternatively, the partition system 1 can be retracted to create a single space.

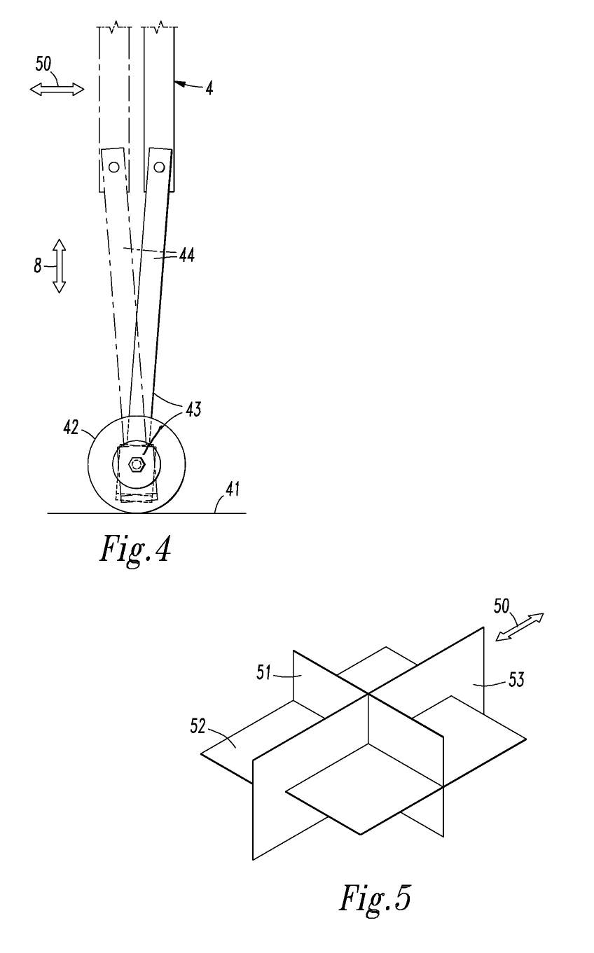

The channel 2 bears little or no vertical load and may be attached to any ceiling member 10 having stability in a horizontal plane 52 as shown in FIG. 5, that is, stability in the lateral dimension. The ceiling member 10 can include, for example, a beam, girder, rafter, joist, or other element present at the ceiling. The ceiling member 10 can include, for example, a grid of a suspended ceiling. Suspended ceilings are common in many buildings including places of assembly, schools, houses of worship, conference rooms, fraternal lodges, funeral parlors, and banquet halls. Suspended ceilings have little vertical strength but the interlocking grid and ceiling tiles provide adequate horizontal strength.

The channel 2 can include mounting bracket 7 and a track 3 along which the trolley 6 can travel. As shown in FIG. 1, the mounting bracket 7 receives the track 3. The mounting bracket 7 can include a plurality of pieces and can connect the channel 2 to the ceiling member 10. For example, the mounting bracket 7 can comprise a J-shaped member that can be secured to the ceiling member 10 and a second member that interlocks with the J-shaped member to form the mounting bracket 7. The mounting bracket 7 can at least partially contain the track 3. Preferably, the track 3 can move relatively to the mounting bracket 7 along a vertical axis 8 of the support pole 4 and can transfer any load in the horizontal plane 52 from the track 3 to mounting bracket 7 and then to the ceiling member 10, thus providing lateral stability for the partition 5. An ability to move in the vertical axis 8 is helpful when the floor 41 or ceiling member 10 is not perfectly level. The channel 2 can conveniently be installed as a single piece or as a multi-piece assembly, and can be secured, with or without the mounting bracket 7, at intervals to the ceiling member 10. The channel 2 comprises any material having suitable strength, such as for example metal or engineering plastic.

When the channel 2 includes a track 3, the track 3 should have sufficient strength to resist sagging, bending, bowing, and lateral forces. In embodiments, the track 3 is substantially self supporting when the partition 5 is retracted. Alternatively, the track 3 can be secured to the channel 2 by a mechanical connection, such as for example, a fastener, a bolt, a rivet, a screw, or adhesive. Preferably, the mechanical connection will permit vertical motion of the track 3 within the channel 2. One such mechanical connection includes a vertically slotted opening through which a fastener secures the track 3 to the channel 2. The track 3 preferably consists essentially of aluminum, but can comprise any suitable metal, plastic, composite material, or combination thereof.

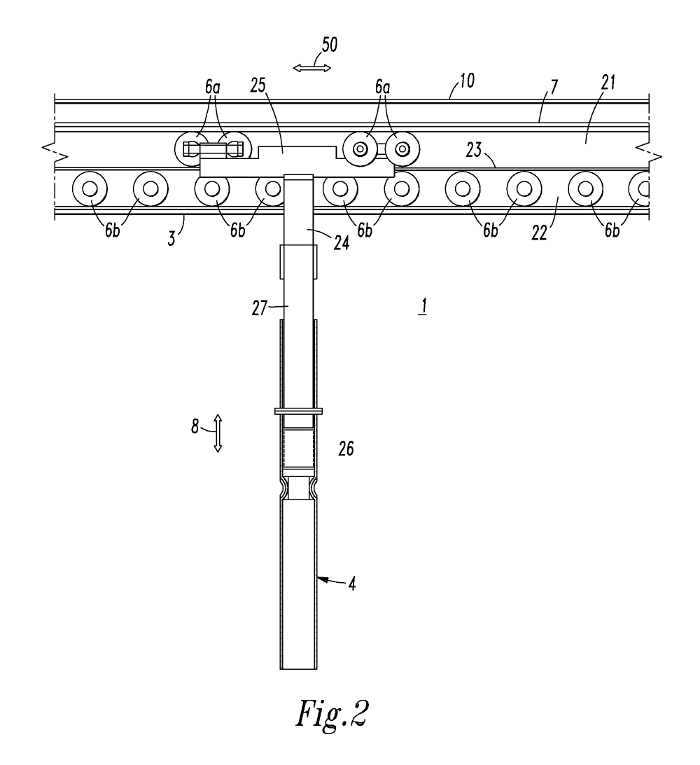

In the embodiment of FIGS. 1 and 2, the channel 2 includes a track 3 that provides an upper raceway 21 for at least one upper trolley 6a. Typically, the partition system 1 will include a truck 25 comprising a plurality of trolleys 6. The number of trucks and trolleys on each truck will be determined by the size and weight of the partition 5 to be supported. The embodiment of FIG. 2 shows a truck 25 comprising four pairs of upper trolleys 6a supporting a single support pole 4. The upper trolley 6a rides in the track 3 along the upper raceway 21. Any lateral force, that is, a force not along a vertical axis 8, from the support pole 4 can be transferred through the upper trolley 6a to the track 3, to the channel 2, and then to the ceiling member 10. This stabilizes the partition 5 in the horizontal plane 52, which is orthogonal to the vertical axis 8.

The trolley 6 can include any low friction device. For example, a trolley 6 could include a bearing comprising a low friction material such as nylon, polyolefins, fluorinated polyolefins, such as Teflon®, or roller bearing or, as shown in FIGS. 1 and 2, a wheeled structure.

In embodiments, the partition system 1 also includes a lower trolley 6b. The upper end 24 of the support pole 4 can connect to a support trolley, that is, either the upper trolley 6a or lower trolley 6b. The remaining trolley can be connected to ribs (not shown) attached to the partition 5. Ribs can increase stiffness of the partition 5 while defining bending points between the ribs that enable the partition 5 to fold at the bending points. The ribs can have a structure similar to the support pole 4 except the ribs will not be directly connected to a weight bearing member 42. In embodiments, a rib can include a vertical rod and at least one hinge. The vertical rod runs substantially the entire vertical dimension of the partition, and the hinge connects the vertical rod to the partition. The trolley and ribs reduce sagging of the partition 5 between trolleys 6. The support pole 4 exerts an upward force on the support trolley that holds up the trolley 6, the partitions 5, and any associated ribs.

FIG. 2 shows a truck 25 comprising a plurality of trolleys 6. The truck 25 permits the trolleys 6 to extend along the track 3, in the direction of motion 50, and can improve lateral stability particularly when the truck 25 includes a plurality of upper trolleys 6a or lower trolleys 6b. In this embodiment, the upper trolley 6a is the support trolley and the lower trolleys 6b are connected to the ribs and partition (not shown). Conveniently, a track 3 includes a divider 23 that separates the track 3 into an upper raceway 21 and a lower raceway 22. The divider 23 between the upper raceway 21 and the lower raceway 22 can physically separate the trolleys 6 so that upper trolleys 6a and lower trolleys 6b do not interfere with each other. Advantageously, the divider 23 between the upper raceway 21 and the lower raceway 22 can also brace the track 3 and increase its stiffness.

The support pole 4 includes an upper end 24 connected to a truck 25 or at least one trolley 6 and a lower end 31 attached to a weight bearing member 42. The partition 5 is attached to the support pole 4 so that moving the partition 5 causes the support pole 4 to move with it. The partition system 1 can include a plurality of support poles 4 and partitions 5. The number of support poles 4 depends on several factors such as, for example, the length, height, and weight of the partitions 5. The support poles 4 transfer the weight of the partitions 5 to the weight bearing members 42 and then to the floor 41. The weight bearing members 42 are capable of moving along the floor 41 without the need for a floor-mounted tracking system or rail. Each weight bearing member 42 comprises an assembly that includes at least one wheel or slide that can be moved across the floor when desired but will otherwise remain in place. To this end, the weight bearing member 42 can include a brake that locks the member in position. The brake can include any conformation known to one skilled in the art.

The weight bearing member 42 preferably includes a castor 43. The castor 43 includes any mechanical construct that offsets the weight bearing member 42 from the vertical axis 8 of the support pole 4. When the partition 5 is moved, the castor 43 tends to move the weight bearing member 42 under the vertical axis 8 of the support pole 4 so that the weight bearing member 42 tracks the support pole 4. The castor 43 can preferably rotate in a horizontal plane 52 so that the weight bearing member 42 moves the support pole 4 toward the vertical axis 8. When the support pole 4 moves away from the vertical axis 8, that is, moves away from plumb, the castor 43 can move in the horizontal plane 52 so that the weight bearing member 42 moves to the vertical axis 8. Moving the partition 5 can initially move the support pole 4 from the vertical axis 8; however, the castor 43 acts to return the support pole 4 to the vertical axis 8. The weight bearing member 42 and castor 43 cooperate to maintain the support pole 4 aligned with the vertical axis 8.

The weight bearing member 42 must be movable across the floor 41 but must not move unless desired. Various factors, such as size and weight of the partition, and the floor composition, will determine the proper weight bearing member. For example, wheels are convenient for most flooring such as carpeted floors, but slides comprising a low friction material can be used on smooth flooring such as tile, hardwood, laminates, or vinyl or other polymeric surfaces. Low friction materials can include, for example, nylon, polyolefins, fluorinated polyolefins, such as Teflon®, or combinations thereof.

The castor 43 can include one or more spindles 44. A plurality of spindles 44 can secure the weight bearing member 42 to a plurality of support poles 4. The spindle 44 can preferably pivot along an aft plane 53. Advantageously, the spindle 44 can function as a castor 43 in either direction of motion 50 without having to rotate weight bearing member 42 as required with many castors. The spindle 44 allows the weight bearing member 42 to change directional movement of the partition 5 without the normal restrictions associated with a castor rotating in the horizontal plane 52.

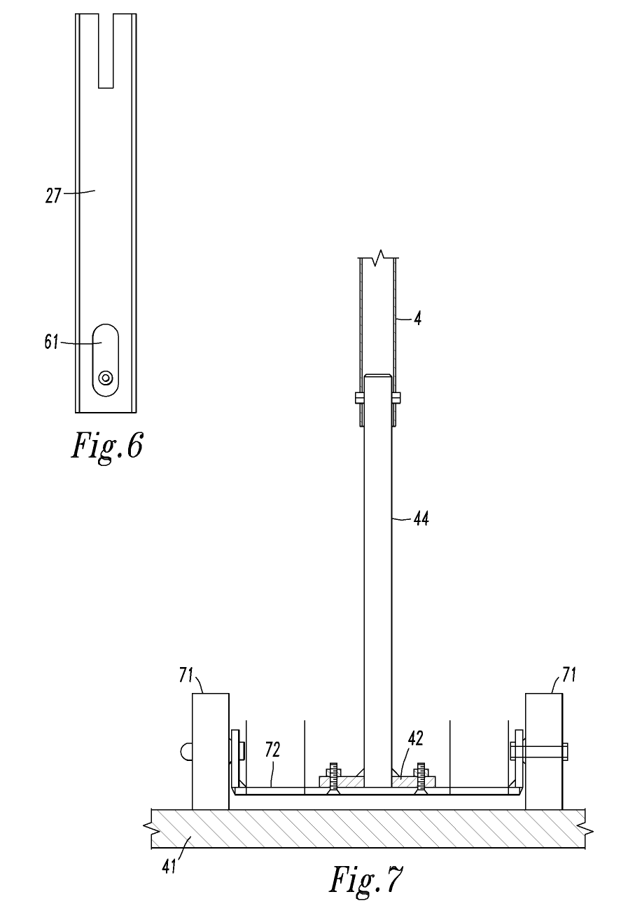

Preferably, the support pole 4 includes a connection 27 that permits the support pole 4 to move either in the vertical plane 51 or rotate around the vertical axis 8. For example, as shown in FIGS. 2 and 6, the upper end of the support pole 4 includes the connection 27, which defines a slotted opening 61 that receives the trolley 6 or truck 25 (not shown). The slotted opening 61 can be oversized relative to the receiving member so that some rotation in the horizontal plane 52 is possible. Alternatively, the connection 27 could occur between the support pole 4 and the weight bearing member 42.

In another aspect, the support pole 4 can include a tensioner 26 that permits variations in the height of the support pole 4. The tensioner 26 is particularly useful when the floor 41 or ceiling member 10 is not level. The tensioner 26 will exert a compressive force between the upper and lower ends of the support pole 4. Advantageously, the tensioner 26 can also resist movement of the trolley 6 from the channel 2 or track 3. The tensioner can include, for example, a spring, strut, or shock absorber that resists compression. The partition system 1 can even be installed with a slight compression on the tensioner 26 so that the support pole 4 firmly seats the trolley 6 in the channel 2 or track 3.

Typically, no modification to the floor 41 is required to install the partition system 1. The partition 5 should have an unobstructed path along the floor 41 beneath the channel 2. The partition 5 can include any movable partition such as, for example, an accordion partition or segmented wall partition. An accordion partition includes any partition assembly in which the partition is engaged with a top track and may be attached to a fixed object at one or both end(s) of the partition run. An accordion partition also includes any type of partition which has vertical sides that are either continuous in nature or one containing some type of slats or a series of panels which are connected together to form a train-like connection or expanding device. Accordion partitions frequently include fabric stretched over a collapsible frame. The collapsible frame can include ribs between support poles or trolleys.

A yoke chain 32 can be attached to the support pole 4 or the collapsible frame of an accordion partition. The yoke chain 32 includes at least two contacts that tend to equalize the force pulling upon the support pole 4 as the partition 5 is being moved. Relative to the direction of motion 50, forces can include a lateral force in a lateral plane 51, a horizontal force in a horizontal plane 52, and aft force in an aft plane 53. Equalization of these forces tends to keep the support pole 4 upright.

In embodiments, as shown in FIG. 7, the weight bearing member 42 includes a plurality of wheels 71 connected by an axle 72. The axle 72 can include a support frame on which the weight bearing member 42 can be fixed. The support pole 4 transfers its load to the weight bearing member 42. Preferably, at least one spindle 44 connects the support pole 4 to the weight bearing member 42. As described above, the spindle 44 provides the weight bearing member 42 with a castor action. A wheel 71 on either side of the support pole 4 improves stability in the lateral plane 51 and horizontal plane 52.

The disclosure has been described with reference to various specific embodiments and techniques. However, many variations and modifications are possible while remaining within the spirit and scope of the disclosure.

1. A floor supported partition system extending from a floor to a ceiling comprising:
a. a channel secured to the ceiling;
b. a truck comprising a trolley that is capable of movement along the channel;
c. a support pole having an upper end, a lower end, and a vertical axis, the upper end mechanically connected to the truck;
d. a partition secured to the support pole along the vertical axis; and
e. a weight bearing member contacting the floor and mechanically connected to the lower end of the support pole.

2. The floor supported partition system of claim 1, wherein the partition is secured to a plurality of adjacent support poles along their vertical axes.

3. The floor supported partition system of claim 1, wherein the channel includes a mounting bracket and a track, and the track is at least partially contained in the mounting bracket.

4. The floor supported partition system of claim 3, wherein the track is capable of vertical movement relative to the mounting bracket.

5. The floor supported partition system of claim 3, wherein the track includes an upper raceway and a lower raceway, and the truck comprises an upper trolley capable of moving along the upper raceway and a lower trolley capable of moving along the lower raceway.

6. The floor supported partition system of claim 5, wherein a divider separates the upper raceway from the lower raceway.

7. The floor supported partition system of claim 5, wherein the upper trolley supports the support pole, and the lower trolley supports the partition.

8. The floor supported partition system of claim 5, wherein the truck comprises a plurality of upper trolleys and a plurality of lower trolleys.

9. The floor supported partition system of claim 1, wherein the trolley comprises a bearing selected from a group consisting of a low friction material, a roller bearing, a wheeled structure, and combinations thereof.

10. The floor supported partition system of claim 9, wherein the low friction material is selected from a group consisting of nylon, polyolefins, fluorinated polyolefins, and combinations thereof.

11. The floor supported partition system of claim 1, wherein the weight bearing member comprises an assembly selected from a group consisting of a wheel, a slide, and combinations thereof.

12. The floor supported partition system of claim 11, wherein the assembly includes a plurality of wheels.

13. The floor supported partition system of claim 11, wherein the slide includes a low friction material selected from a group consisting of nylon, fluorinated polyolefins, polyolefins, and combinations thereof.

14. The floor supported partition system of claim 1, wherein the weight bearing member includes a brake that locks the weight bearing member in position.

15. The floor supported partition system of claim 1, wherein the weight bearing member includes a castor that offsets the weight bearing member from the vertical axis of the support pole.

16. The floor supported partition system of claim 15, wherein the castor includes at least one spindle that secures the weight bearing member to a plurality of support poles.

17. The floor supported partition system of claim 1, wherein the support pole comprises a tensioner that exerts a compressive force between the upper end and the lower end of the support pole.

18. A floor supported partition system extending from a floor to a ceiling comprising:
a. a channel secured to the ceiling and defining a track;
b. a trolley that is capable of movement along the track;
c. a support pole comprising an upper end, a lower end and a vertical axis, the upper end secured to the trolley;
d. a partition secured to the support pole along the vertical axis; and
e. a weight bearing member contacting the floor and mechanically connected to the lower end of the support pole.

19. A floor supported partition system extending from a floor to a ceiling comprising:
a. a channel including a mounting bracket and a track, the mounting bracket secured to the ceiling, and the track at least partially contained in the mounting bracket and is capable of vertical movement relative to the mounting bracket;
b. a truck comprising a plurality of trolleys capable of movement along the track;
c. a support pole comprising an upper end, a lower end and a vertical axis, the upper end secured to the truck;
d. a partition secured to the support pole along the vertical axis; and
e. a weight bearing member contacting the floor and mechanically connected to the lower end of the support pole, the weight bearing member comprising a castor that offsets the weight bearing member from the vertical axis of the support pole.
